(19) United States
(12) Patent Application Publication
(10) Pub. No.: US 2019/0326751 A1
(43) Pub. Date: Oct. 24, 2019

(54) ESD PROTECTION CIRCUIT, RELATED DISPLAY PANEL WITH PROTECTION AGAINST ESD, AND ESD PROTECTION STRUCTURE

(71) Applicant: AU Optronics Corporation, Hsin-Chu (TW)

(72) Inventor: Peng-Bo XI, HSIN-CHU (TW)

(21) Appl. No.: 16/385,003

(22) Filed: Apr. 16, 2019

Related U.S. Application Data
(60) Provisional application No. 62/659,662, filed on Apr. 18, 2018.

(51) Int. Cl. H02H 9/04

(52) U.S. Cl. CPC H02H 9/046

(57) ABSTRACT

An ESD protection circuit includes a first diode element, a second diode element, a first clamping circuit, a second clamping circuit, and a protection circuit. The first diode element is coupled between a first power node and an input node, wherein the input node is coupled with an internal circuit. The second diode element is coupled between a second power node and the input node. The first clamping circuit is coupled between the first power node and the second power node. The second clamping circuit is coupled between the second power node and the input node. The protection circuit is coupled between the first power node and the second power node, and configured to transmit a current corresponding to an ESD event to a grounded capacitor.

### CROSS-REFERENCE TO RELATED APPLICATION

This application claims priority to U.S. Provisional Application Ser. No. 62/659,662, filed Apr. 18, 2018, which is herein incorporated by reference in its entirety.

### BACKGROUND

### Field of Invention

The present disclosure relates to an ESD protection circuit, a display panel with protection against ESD, and an ESD protection structure. More particularly, the present disclosure relates to an ESD protection circuit including a clamping circuit including a switch and a sensing circuit.

### Description of Related Art

The display panel manufacturing process consists of the array process, the cell process, and the module process. Electrostatic discharge (ESD) protection circuits are fabricated on the glass substrate during the array process to prevent pixels and peripheral driving circuits from damaged by the ESD event in the following processes. A clamping circuit of the conventional ESD protection circuit provides a discharging path for a current corresponding to the ESD event by applying the breakthrough effect of a transistor. The breakthrough effect, however, brings irreversible damage to the transistor. Therefore, the conventional ESD protection circuit provides very limited times of protection, which results that the display panel may still be damaged during the numerous steps of the cell and module processes. With respect to micro-LED displays, the mass transfer technology renders the manufacturing process more complicated, and thus the conventional ESD protection circuit is even more unsuitable for the micro-LED displays.

### SUMMARY

The disclosure provides an ESD protection circuit including a first diode element, a second diode element, a first clamping circuit, a second clamping circuit, and a protection circuit. The first diode element is coupled between a first power node and an input node, wherein the input node is coupled with an internal circuit. The second diode element is coupled between a second power node and the input node. The first clamping circuit is coupled between the first power node and the second power node. The second clamping circuit is coupled between the second power node and the input node. The protection circuit is coupled between the first power node and the second power node, and configured to transmit a current corresponding to an ESD event to a grounded capacitor.

The disclosure provides a display panel with protection against ESD. The display panel including an active area, a gate driver, and a plurality of ESD protection circuits. The active area includes a plurality of pixels. The gate driver is configured to drive the plurality of pixels. The plurality of ESD protection circuits is disposed in the active area or a peripheral area surrounding the active area, and configured to provide a plurality of control signals to the gate driver. Each of the plurality of ESD protection circuits includes a first diode element, a second diode element, a first clamping circuit, a second clamping circuit, and a protection circuit. The first diode element is coupled between a first power node and an input node, and the input node is configured to receive one of the plurality of control signals. The second diode element is coupled between a second power node and the input node. The first clamping circuit is coupled between the first power node and the second power node. The second clamping circuit is coupled between the second power node and the input node. The protection circuit is coupled between the first power node and the second power node, and configured to transmit a current corresponding to an ESD event to a grounded capacitor.

The disclosure provides an ESD protection structure including a first electrode, a second electrode, a third electrode, a first transistor structure, a second transistor structure, a first clamping structure, a second clamping structure, and a protection structure. The first electrode and the second electrode are disposed as extending along with a first direction. The third electrode is disposed as extending along with a second direction. The first direction is substantially perpendicular to the second direction. A drain of the first transistor structure is coupled with the first electrode, and a gate and a source of the first transistor structure is coupled with the third electrode. A drain of the second transistor structure is coupled with the third electrode, and a gate and a source of the second transistor structure is coupled with the second electrode. The first clamping structure is coupled with the first electrode and the second electrode. The second clamping structure is coupled with the second electrode and the third electrode. The protection structure is coupled with the first electrode and the second electrode. The first transistor structure, the second transistor structure, the first clamping structure, the second clamping structure, and the protection structure are disposed between the first electrode and the second electrode.

It is to be understood that both the foregoing general description and the following detailed description are by examples, and are intended to provide further explanation of the disclosure as claimed.

### BRIEF DESCRIPTION OF THE DRAWINGS

FIG. 1 is a functional block diagram of an ESD protection circuit according to one embodiment of the present disclosure.

FIG. 2A is a schematic diagram illustrating current paths in a situation that the ESD protection circuit of FIG. 1 receives a positive surge current corresponding to an ESD event.

FIG. 2B is a schematic diagram illustrating current paths in a situation that the ESD protection circuit of FIG. 1 receives a negative surge current corresponding to an ESD event.

FIG. 3 is a schematic top view of an ESD protection structure corresponding to the ESD protection circuit of FIG. 1 according to one embodiment of the present disclosure.

FIG. 4 is a block functional diagram of another ESD protection circuit according to one embodiment of the present disclosure.

FIG. 5 is a schematic diagram illustrating current paths in a situation that the ESD protection circuit of FIG. 4 receives a negative surge current corresponding to an ESD event.

FIG. 6 is a functional block diagram of yet another ESD protection circuit according to one embodiment of the present disclosure.

FIG. 7 is a simplified functional block diagram of a display panel according to one embodiment of the present disclosure.

FIG. 8 is a simplified functional block diagram of another display panel according to one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

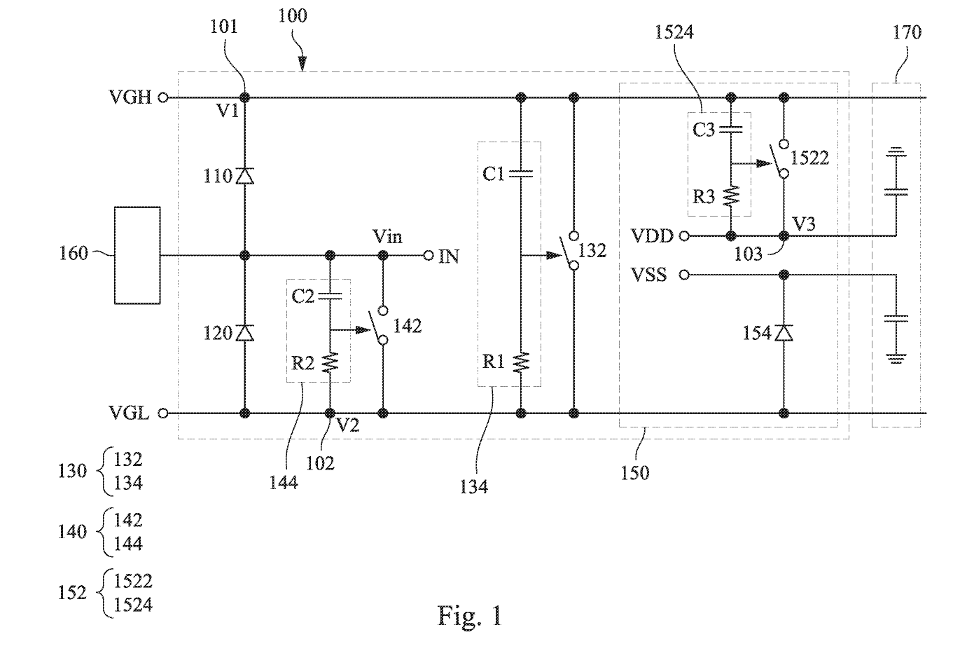

FIG. 1 is a functional block diagram of an ESD protection circuit 100 according to one embodiment of the present disclosure. The ESD protection circuit 100 comprises a first diode element 110, a second diode element 120, a first clamping circuit 130, a second clamping circuit 140, and a protection circuit 150. An input node IN of the ESD protection circuit 100 is coupled with an internal circuit 160, protected by the ESD protection circuit 100, and the input node IN is configured to receive signals that the internal circuit 160 needs.

A first node of the first diode element 110 (e.g., an anode) is coupled with the input node IN. A second node of the first diode element 110 (e.g., an cathode) is coupled with the a first power node VGH. A first node of the second diode element 120 (e.g., an anode) is coupled with a second power node VGL. A second node of the second diode element 120 (e.g., an cathode) is coupled with the input node IN. The first clamping circuit 130 is coupled between the first power node VGH and the second power node VGL. The second clamping circuit 140 is coupled between the second power node VGL and the input node IN. The protection circuit 150 is coupled between the first power node VGH and the second power node VGL.

When an ESD event occurs at the input node IN, a surge current corresponding to the ESD event may flow through the first diode element110 or the second diode element120, and flow through at least one of the first clamping circuit 130 and the second clamping circuit 140. Therefore, the surge current is finally transmitted to the protection circuit 150, and the protection circuit 150 discharges the surge current to a grounded capacitor 170 coupled with the protection circuit 150. Notably, the grounded capacitor 170 described in this disclosure may be one or more parasitic capacitors formed by overlapped components in the internal circuit 160, and needs not to be an actual capacitor element that specially created.

In one embodiment, for example, the protection circuit 150 discharges the surge current to one or more power lines of the internal circuit 160. Since the one or more power lines are configured to supply power input to many components of the internal circuit 160, the one or more power lines are widely spread in the internal circuit 160 and overlaps with numerous components. As a result, parasitic capacitors, with large capacitance, that capable of enduring the surge current are formed.

The first clamping circuit 130 comprises a first switch 132 and a first sensing circuit 134. A first node of the first switch 132 is coupled with the first power node VGH through the first node 101. A second node of the first switch 132 is coupled with the second power node VGL through the second node 102. The first sensing circuit 134 is coupled between the first node 101 and the second node 102. The first sensing circuit 134 is configured to control the first switch 132 according to a first node voltage V1 of the first node 101 and a second node voltage V2 of the second node 102. Specifically, the first sensing circuit 134 comprises a first resistor R1 and a first capacitor C1. The first capacitor C1 is coupled between the first node 101 and the first switch 132. The first resistor R1 is coupled between a control node of the first switch 132 and the second node 102.

The second clamping circuit 140 comprises a second switch 142 and a second clamping circuit 144. A first node of the second switch 142 is coupled with the input node IN. A second node of the second switch 142 is coupled with the second node 102. The second clamping circuit 144 is coupled between the input node IN and the second node 102. The second clamping circuit 144 is configured to control the second switch 142 according to the second node voltage V2 and an input node voltage Vin of the input node IN. Specifically, the second clamping circuit 144 comprises a second capacitor C2 and a second resistor R2. The second capacitor C2 is coupled between the input node IN and a control node of the second switch 142. The second resistor R2 is coupled between the control node of the second switch 142 and the second node 102.

The protection circuit 150 comprises a third clamping circuit 152 and a third diode element 154. The third clamping circuit 152 is coupled between the first power node VGH and the third power node VDD. The third diode element 154 is coupled between the second power node VGL and the fourth power node VSS. The third clamping circuit 152 comprises the third switch 1522 and the third sensing circuit 1524. A first node of the third switch 1522 is coupled with the first node 101. A second node of the third switch 1522 is coupled with the third power node VDD through the third node 103. The third sensing circuit 1524 is coupled between the first node 101 and the third node 103. The third sensing circuit 1524 is configured to control the third switch 1522 according to the first node voltage V1 and a third node voltage V3 of the third node 103. In addition, the third sensing circuit 1524 comprises a third capacitor C3 and a third resistor R3. The third capacitor C3 is coupled between the first node 101 and a control node of the third switch 1522. The third resistor R3 is coupled between the control node of the third switch 1522 and the third node 103.

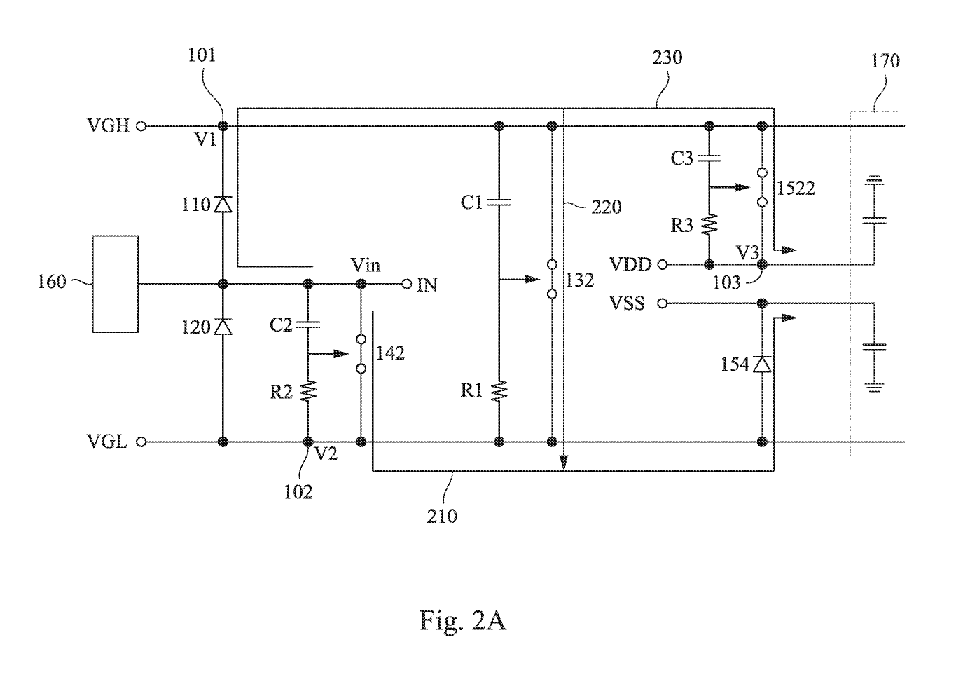

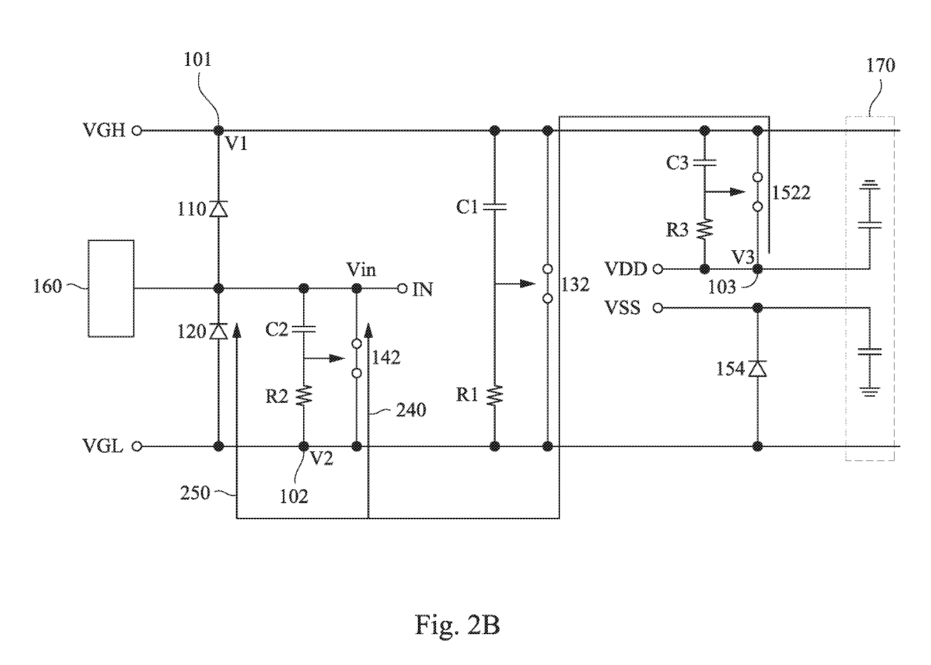

FIG. 2A is a schematic diagram illustrating current paths in a situation that the ESD protection circuit 100 receives a positive surge current corresponding to an ESD event. When the input node IN receives the positive surge current, the first diode element 110 and the second clamping circuit 140 are conducted. Specifically, a voltage of the control node of the second switch 142 is switched to a logic high level because of the capacitive coupling effect, while the second resistor R2 reduces the discharging speed of the second capacitor C2. Therefore, the second switch 142 is conducted during the ESD event. Similarly, voltages of the control nodes of the first switch 132 and the third switch 1522 are also switched to the logic high level because of the capacitive coupling effect, while the first resistor R1 and the third resistor R3 reduce the discharging speed of the first capacitor C1 and the third capacitor C3. As a result, the first switch 132 and the third switch 1522 are conducted during the ESD event.

As a result, the positive surge current may be discharged to the grounded capacitor 170 via current paths as fallow: a current path 210 starts from the input node IN to the grounded capacitor 170 via the second switch 142 and the third diode element 154; a current path 220 starts from the input node IN to the grounded capacitor 170 via the first diode element 110, the first switch 132, and the third diode element 154; and a current path 230 starts from the first power node VGL to the second power node VGH via the first diode element 110 and the third switch 1522.

FIG. 2B is a schematic diagram illustrating current paths in a situation that the ESD protection circuit 100 receives a negative surge current corresponding to an ESD event. When the input node IN receives the negative surge current, the second diode element 120 is conducted. The second resistor R2 limits the charging speed of the second capacitor C2, so that the second node voltage V2 is larger than the voltage of the control node of the second switch 142, and the voltage of the control node of the second switch 142 is larger than the input node voltage Vin. Therefore, the second switch 142 is conducted during the ESD event. The first resistor R1 limits the discharging speed of the first capacitor C1, so that the first node voltage V1 is larger than the voltage of the control node of the first switch 132, and the voltage of the control node of the first switch 132 is larger than the second node voltage V2. Therefore, the first switch 132 are also conducted during the ESD event. In addition, similar to the operation of the second clamping circuit 140, the third resistor R3 limits the charging speed of the third capacitor C3, so that the third switch 1522 is conducted during the ESD event.

As a result, the negative surge current may be discharged to the grounded capacitor 170 via current paths as fallow: a current path 240 starts from the input node IN to the grounded capacitor 170 via the third switch 1522, the first switch132, and the second switch 142; and a current path 250 starts from the input node IN to the grounded capacitor 170 via the third switch 1522, the first switch 132, and the second diode element 120.

In practice, the first diode element 110, the second diode element 120, and the third diode element 154 may be realized by general diodes, or may be realized by P-type or N-type transistors which are diode-connected. The first switch 132, the second switch 142, and the third switch 1522 may be realized by N-type ore P-type transistors. In one embodiment, the first power node VGH, the second power node VGL, the third power node VDD, and fourth power node VSS are coupled with the internal circuit 160, and are configured to respectively supply different voltages to the internal circuit 160. In another embodiment, the first power node VGH and the second power node VGL are configured to respectively provide the highest and the lowest voltages needed by the internal circuit 160.

Accordingly, the components comprised by the ESD protection circuit 100 are prevented from breakthrough during the ESD event, and thus the ESD protection circuit 100 has advantages of long life time and high reliability.

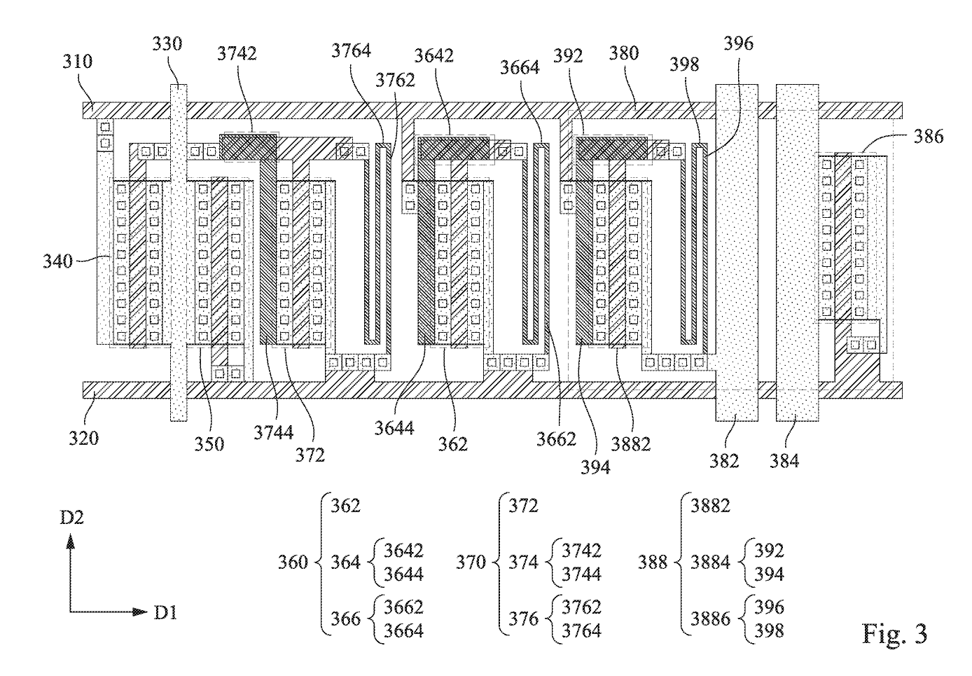

FIG. 3 is a schematic top view of an ESD protection structure corresponding to the ESD protection circuit 100 of FIG. 1 according to one embodiment of the present disclosure. The ESD protection structure comprises a first electrode 310, a second electrode 320, a third electrode 330, a first transistor structure 340, a second transistor structure 350, a first clamping structure 360, a second clamping structure 370, and a protection structure 380. The first power node VGH, second power node VGL, and input node IN of FIG. 1 are located on the first electrode 310, second electrode 320, and third electrode 330, respectively. The first diode element 110, second diode element 120, first clamping circuit 130, second clamping circuit 140, and protection circuit 150 of FIG. 1 are corresponding to the first transistor structure 340, second transistor structure 350, first clamping structure 360, second clamping structure 370, and protection structure 380 of FIG. 3, respectively.

The first electrode 310 and the second electrode 320 are disposed as extending along with the first direction D1. The third electrode 330 is disposed as extending along with the second direction D2, and the first direction D1 is substantially perpendicular to the second direction D2. A drain of the first transistor structure 340 is coupled with the first electrode 310. A gate and a source of the first transistor structure 340 are coupled with the third electrode 330. A drain of the second transistor structure 350 is coupled with the third electrode 330. A gate and a source of the second transistor structure 350 is coupled with the second electrode 320. The first clamping structure 360 and the protection structure 380 are coupled with the first electrode 310 and the second electrode 320. The second clamping structure 370 is coupled with the second electrode 320 and the third electrode 330.

The first transistor structure 340, the second transistor structure 350, the first clamping structure 360, the second clamping structure 370, and the protection structure 380 are disposed between the first electrode 310 and the second electrode 320.

The first clamping structure 360 comprises a third transistor structure 362, a first capacitor structure 364, and a first resistor structure 366. The third transistor structure 362, first capacitor structure 364, and first resistor structure 366 are corresponding to the first switch 132, first capacitor C1, and first resistor R1 of FIG. 1, respectively. The first capacitor structure 364 comprises a first geometric structure 3642 and a first extension portion 3644. The first geometric structure 3642 is disposed between the third transistor structure 362 and the first electrode 310, and a button plate of the first geometric structure 3642 is coupled with the gate of the third transistor structure 362. The first extension portion 3644 is coupled with a top plate of the first geometric structure 3642 and the drain of the third transistor structure 362, namely, the first extension portion 3644 is disposed as extending from the top plate of the first geometric structure 3642 to the second electrode 320. The first resistor structure 366 is coupled with the gate of the third transistor structure 362, the source of the third transistor structure 362, and the second electrode 320. The first resistor structure 366 comprises a plurality of first main portions 3662 and a plurality of first connection portions 3664. The plurality of first main portions 3662 are disposed as extending along with the second direction D2. The plurality of first connection portions 3664 are disposed as extending along with the first direction D1, and each of the first connection portions 3664 is coupled between two adjacent first main portions 3662 of the plurality of first main portions 3662.

The second clamping structure 370 comprises a fourth transistor structure 372, a second capacitor structure 374, and a second resistor structure 376. The fourth transistor structure 372, the second capacitor structure 374, and the second resistor structure 376 are corresponding to the second switch 142, second capacitor C2, and second resistor R2 of FIG. 1, respectively. The second capacitor structure 374 comprises a second geometric structure 3742 and a second extension portion 3744. The second geometric structure 3742 is disposed between the second transistor structure 350 and the first electrode 310, and a button plate of the second geometric structure 3742 is coupled with a gate of the fourth transistor structure 372. The second extension portion 3744 is coupled with a top plate of the second geometric structure 3742 and a drain of the fourth transistor structure 372. The second extension portion 3744 is disposed as extending from the top plate of the second geometric structure 3742 to the second electrode 320. The second resistor structure 376 is coupled with the gate of the fourth transistor structure 372, a source of the fourth transistor structure 372, and the second electrode 320. The second resistor structure 376 comprises a plurality of second main portions 3762 and a plurality of second connection portions 3764. The plurality of second main portions 3762 are disposed as extending along with the second direction D2. The plurality of second connection portions 3764 are disposed as extending along with the first direction D1, and each of the second connection portions 3764 is coupled between two adjacent second main portions 3762 of the plurality of second main portions 3762.

The protection structure 380 comprises a fourth electrode 382, a fifth electrode384, a fifth transistor structure 386, and a third clamping structure 388. The fourth electrode 382 and the fifth electrode 384 are disposed along with the second direction D2. A drain of the fifth transistor structure 386 is coupled with the fifth electrode 384. A gate and a source of the fifth transistor structure 386 are coupled with the second electrode 320. In addition, the fifth electrode 384 is disposed between the fourth electrode 382 and the fifth transistor structure 386.

The third clamping structure 388 comprises a sixth transistor structure 3882, a third capacitor structure 3884, and a third resistor structure 3886. The third capacitor structure 3884comprises a third geometric structure 392 and a third extension portion 394. The third geometric structure 392 is disposed between the sixth transistor structure 3882 and the first electrode 310, and a button plate of the third geometric structure 392 is coupled with a gate of the sixth transistor structure 3882. The third extension portion 394 is coupled with a top plate of the third geometric structure 392 and a drain of the sixth transistor structure 3882. The third extension portion 394 is disposed as extending from the top plate of the third geometric structure 392 to the second electrode 320. The third resistor structure 3886 is coupled with the gate of the sixth transistor structure 3882, the source of the sixth transistor structure 3882, and the fourth electrode 382. The third resistor structure 3886 comprises a plurality of third main portions 396 and a plurality of third connection portions 398. The plurality of third main portions 396 is disposed as extending along with the second direction D2. The plurality of third connection portions 398 is disposed as extending along with the first direction D1, and each of the third connection portions 398 is coupled between two adjacent third main portions 396 of the plurality of third main portions 396.

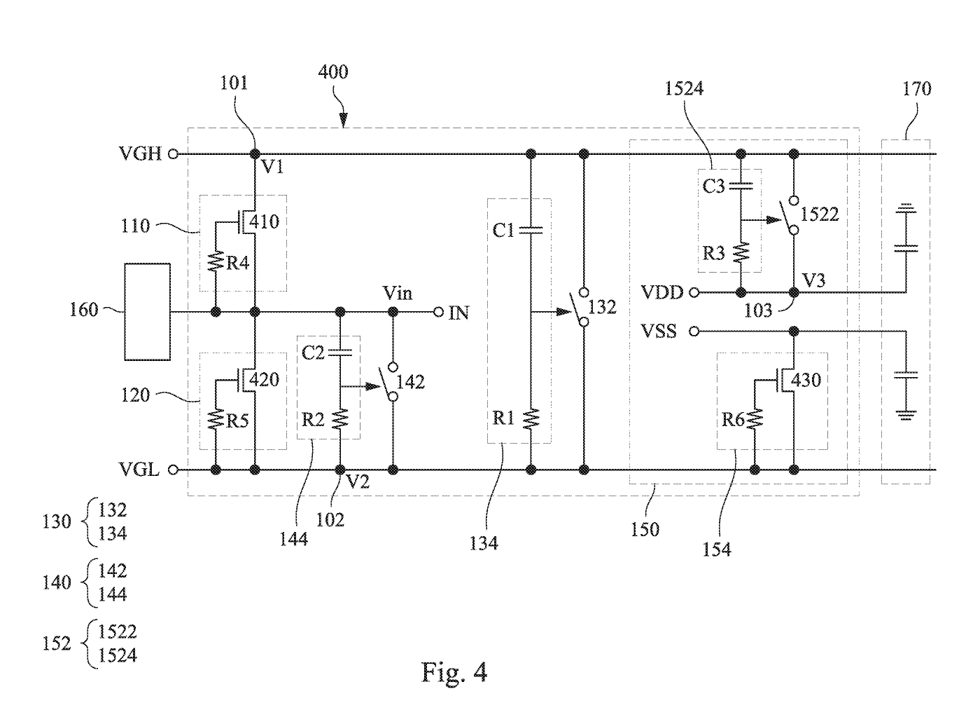

FIG. 4 is a block functional diagram of an ESD protection circuit 400 according to one embodiment of the present disclosure. The ESD protection circuit 400 of FIG. 4 is similar to the ESD protection circuit 100 of FIG. 1, the differences are described as fallow: the first diode element 110 of the ESD protection circuit 400 comprises a first transistor 410 and a fourth resistor R4; the second diode element 120 of the ESD protection circuit 400 comprises a second transistor 420 and a fifth resistor R5; the third diode element 154 of the ESD protection circuit 400 comprises a third transistor 430 and a sixth resistor R6.

A first node of the first transistor 410 is coupled with the first node 101. A second node of the first transistor 410 is coupled with the input node IN. The fourth resistor R4 is coupled between a control node of the first transistor 410 and the input node IN. A first node of the second transistor 420 is coupled with the input node IN. A second node of the second transistor 420 is coupled with the second power node VGL. The fifth resistor R5 is coupled between the control node of the second transistor 420 and the second power node VGL. A first node of the third transistor 430 is coupled with the fourth power node VSS. A second node of the third transistor 430 is coupled with the second power node VGL. The sixth resistor R6 is coupled between a control node of the third transistor 430 and the second power node VGL.

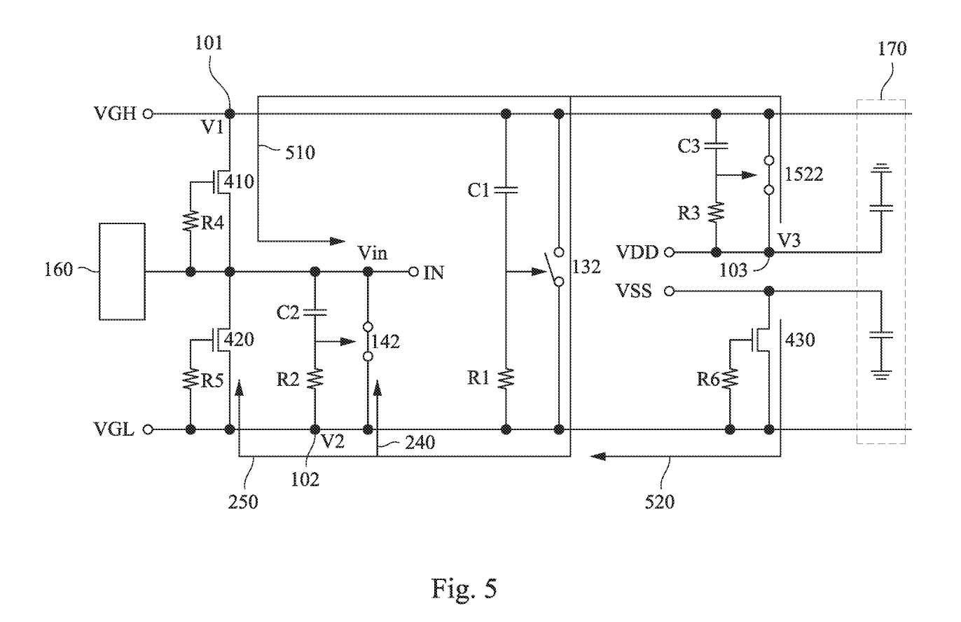

FIG. 5 is a schematic diagram illustrating current paths in a situation that the ESD protection circuit 400 receives a negative surge current corresponding to an ESD event. The first resistor R1 and the third resistor R3 limit the discharging speeds of the first transistor 410 and the third transistor 430, respectively. Therefore, when the input node IN receives the negative surge current, the voltage of the control node of the first transistor 410 is higher than the input node voltage Vin, and the voltage of the control node of the third transistor 430 is higher than the second node voltage V2. As a result, the ESD protection circuit 400 not only provides the current path 240 and the current path 250, but also provides the following additional current paths for discharging the negative surge current to the grounded capacitor 170: a current path 510 starts from the grounded capacitor 170 to the input node IN via the third switch 1522 and the first transistor 410; and a current path 520 starts from the grounded capacitor 170 to the second node 102 via the third transistor 430. Current paths, which are corresponding to a situation that the ESD protection circuit 400 receives a positive surge current, are similar to the current paths shown in FIG. 2A. The foregoing descriptions regarding the implementations, connections, operations, and related advantages of other corresponding functional blocks in the ESD protection circuit 100 are also applicable to the ESD protection circuit 400. For the sake of brevity, those descriptions will not be repeated here.

Notably, during the ESD event, the current paths of the foregoing embodiments need not to exist simultaneously. For example, at least one of the current path 210, current path 220, and current path 230 of FIG. 2A should exist, but the current path 210, the current path 220, and the current path 230 need not to exist simultaneously. As another example, at least one of the current path 240 and current path 250 of FIG. 2B should exist, but the current path 240 and the current path 250 need not to exist simultaneously. As yet another example, at least one of the current path 240, current path 250, current path 510, and current path 520 of FIG. 5 should exist, but the current path 240, the current path 250, the current path 510, and the current path 520 need not to exist simultaneously.

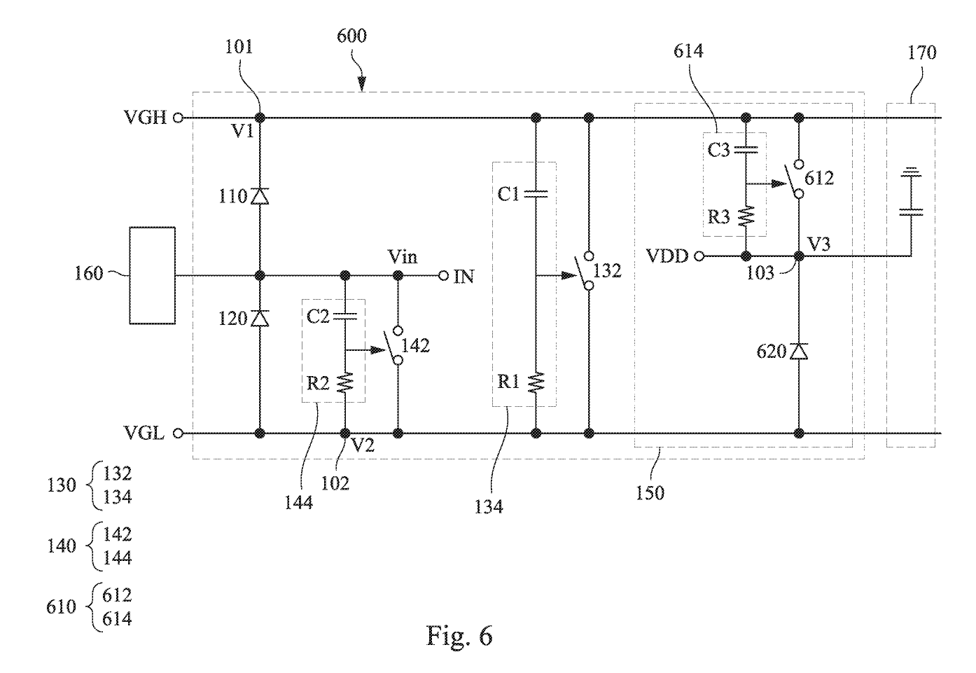

FIG. 6 is a functional block diagram of an ESD protection circuit 600 according to one embodiment of the present disclosure. The ESD protection circuit 600 of FIG. 6 is similar to the ESD protection circuit 100 of FIG. 1, the differences are described as follow: the protection circuit 150 of the ESD protection circuit 600 comprises a third clamping circuit 610 and a third diode element 620, and the third clamping circuit 610 is coupled between the first power node VGH and the third power node VDD; a first node of the third diode element 620 (e.g., an anode) is coupled with the second power node VGL, and a second node of the third diode element 620 (e.g., a cathode) is coupled with the third power node VDD.

Specifically, the third clamping circuit 610 comprises a third switch 612 and a third sensing circuit 614. A first node of the third switch 612 is coupled with the first power node VGH through the first node 101. A second node of the third switch 612 is coupled with the third power node VDD through the third node 103. The third sensing circuit 614 is coupled between the first node 101 and the third node 103. The third sensing circuit 614 is configured to control the third switch 612 according to the first node voltage V1 and the third node voltage V3. The third sensing circuit 614 comprises a third capacitor C3 and a third resistor R3. The third capacitor C3 of the third sensing circuit 614 is coupled between the first node 101 and a control node of the third switch 612. The third resistorR3 of the third sensing circuit 614 is coupled between the control node of the third switch 612 and the third node 103.

The circuit layout of the ESD protection circuit 600 is similar to that of the ESD protection structure shown in FIG. 3. The different is that the third resistor R3, the second node of the third switch 612, and the third diode element 620 of the ESD protection circuit 600 are coupled with the same electrode. Therefore, the ESD protection circuit 600 has an advantage of small circuit area. The foregoing descriptions regarding the implementations, connections, operations, and related advantages of the ESD protection circuit 100 of FIG. 1 are also applicable to the ESD protection circuit 600 of FIG. 6. For the sake of brevity, those descriptions will not be repeated here.

In some embodiments, the ESD protection circuit 600 comprises a plurality of protection circuits 150 coupled in parallel connections between the first power node VGH and the second power node VGL. Each of the plurality of protection circuits 150 may be coupled with the grounded capacitor 170 through different power lines. For example, the third power node VDD of one protection circuit 150 is configured to provide a first reference voltage to the internal circuit 160, while the third power node VDD of another protection circuit 150 is configured to provide a second reference voltage to the internal circuit 160.

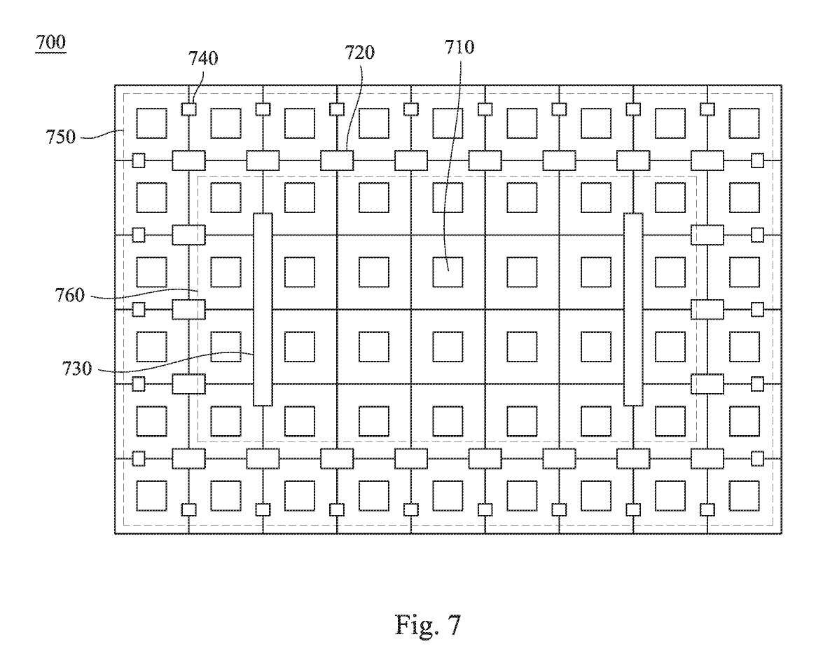

FIG. 7 is a simplified functional block diagram of a display panel 700 according to one embodiment of the present disclosure. The display panel 700 comprises a plurality of pixels 710, a plurality of ESD protection circuits 720, at least one gate driver 730, and a plurality of signal pins 740. The plurality of pixels 710 are arrange as a matrix in an active area 750. The plurality of ESD protection circuits 720 are arranged as a loop in the active area 750, more specifically, the plurality of ESD protection circuits 720 are arranged as a rectangular loop. The plurality of ESD protection circuits 720 surround part of the plurality of pixels 710, e.g., the pixels 710 in a rectangular area 760. The numbers of the pixels 710, the ESD protection circuits 720, and the signal pins 740 are merely exemplary embodiments, and are not intend to restrict the practical implementation of the disclosure. For example, the numbers of the pixels 710, the ESD protection circuits 720, and the signal pins 740 may be positive correlated with the resolution of the display panel 700.

In practice, the pixels 710 can be realized by micro-LED chips. The after-cutting micro-LED chips may be transferred, by the mass transfer technology, from the LED substrate to the circuit substrate of the display panel 700. The display panel 700 may be realized as a tiled display panel, and a plurality of display panels 700 may be tiled as a videowall.

The gate driver 730 is configured to control the operation of data writing and/or emission of the plurality of pixels 710. The plurality of signal pins 740 are configured to receive the signals needed by the gate driver 730 and/or the plurality of pixels 710, such as the clock signal, the power signal, the data signal, and scanning start signal, etc. The plurality of signal pins 740 transmit the received signals to corresponding ESD protection circuits 720. Each of the plurality of ESD protection circuits 720 may be the aforementioned ESD protection circuit 100 or the ESD protection circuit 400, and the third power node VDD and the fourth power node VSS are configured to respectively provide high and low operating voltages to the pixel 710, so that the pixel 710 generates a current for driving the micro-LED. The plurality of ESD protection circuits 720 transmit the received signals to the plurality of pixels 710 and the gate driver 730, namely, the plurality of pixels 710 and the gate driver 730 internal circuit160 correspond to the internal circuit 160 of the aforementioned embodiments.

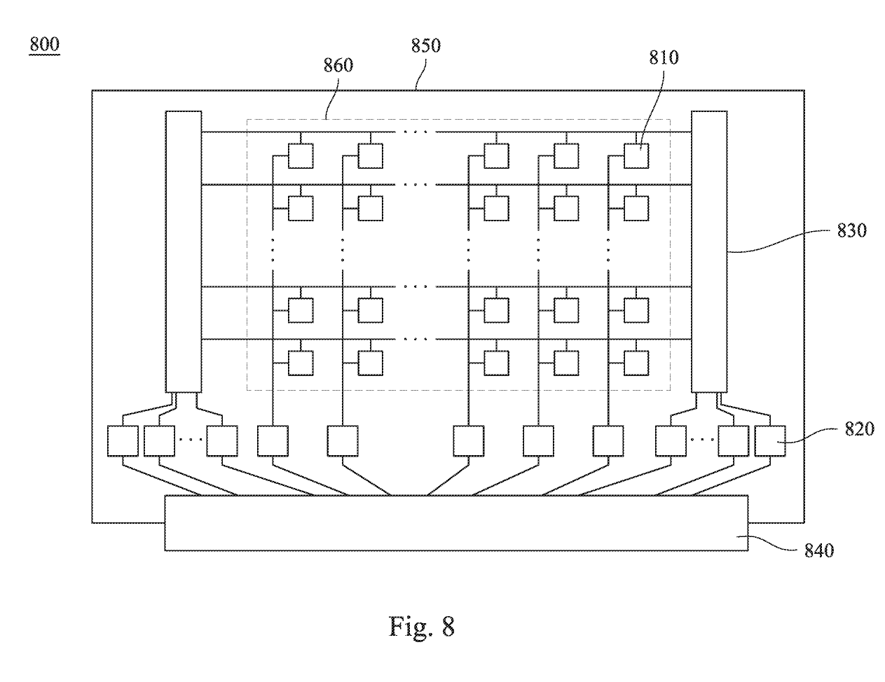

FIG. 8 is a simplified functional block diagram of a display panel 800 according to one embodiment of the present disclosure. The display panel 800 comprises a plurality of pixels 810, a plurality of ESD protection circuits 820, at least one gate driver 830, a control circuit 840, and a substrate 850. The plurality of pixels 810 are arranged in an active area 860 on the substrate 850. The gate driver 830 are configured to control the operations of data writing and/or emission of the plurality of pixels 810. The control circuit 840 is configured to provide the signals needed by the gate driver 830 and the plurality of pixels 810, such as the clock signal, the power signal, the data signal, and scanning start signal, etc. The ESD protection circuit 820 is coupled between the control circuit 840 and the gate driver 830, and also coupled between the control circuit 840 and the plurality of pixels 810. That is, the gate driver 830 and the plurality of pixels 810 correspond to the internal circuit 160 of the aforementioned embodiments.

In an embodiment that the pixel 810 use the organic light-emitting diode (OLED) as the emitting element, the ESD protection circuit 820 may be the aforementioned ESD protection circuit 100, ESD protection circuit 400, or the ESD protection circuit 600. The third power node VDD and the fourth power node VSS are configured to respectively provide high and low operating voltages to the pixel 810, so that the pixel 810 generates a current for driving the OLED.

On the other hand, in another embodiment that the pixel 810 uses the liquid-crystal to control the gray level, the ESD protection circuit 820 may be the aforementioned ESD protection circuit 600, and the third power node VDD is configured to provide the common voltage to the pixel 810.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.” The term “couple” is intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The term “and/or” may comprise any and all combinations of one or more of the associated listed items. In addition, the singular forms “a,” “an,” and “the” herein are intended to comprise the plural forms as well, unless the context clearly indicates otherwise.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An ESD protection circuit, comprising:
a first diode element, coupled between a first power node and an input node, wherein the input node is coupled with an internal circuit;
a second diode element, coupled between a second power node and the input node;
a first clamping circuit, coupled between the first power node and the second power node;
a second clamping circuit, coupled between the second power node and the input node; and
a protection circuit, coupled between the first power node and the second power node, and configured to transmit a current corresponding to an ESD event to a grounded capacitor.

2. The ESD protection circuit of claim 1, wherein the first clamping circuit comprises:
a first switch, comprising a first terminal, a second terminal, and a control terminal, wherein the first terminal of the first switch is coupled with the first power node through a first node, the second terminal of the first switch is coupled with the second power node through a second node; and
a first sensing circuit, coupled between the first node and the second node, and configured to control the first switch according to a first node voltage of the first node and a second node voltage of the second node;
wherein the second clamping circuit comprising:
a second switch, comprising a first terminal, a second terminal, and a control terminal, wherein the first terminal of the second switch is coupled with the input node, the second terminal of the second switch is coupled with the second power node through the second node; and
a second clamping circuit, coupled between the input node and the second node, and configured to control the second switch according to an input node voltage of the input node and the second node voltage.

3. The ESD protection circuit of claim 2, wherein the first sensing circuit comprises:
a first capacitor, coupled between the first node and the control terminal of the first switch; and
a first resistor, coupled between the control terminal of the first switch and the second node.

4. The ESD protection circuit of claim 2, wherein the first sensing circuit comprises:
a second capacitor, coupled between the input node and the control terminal of the second switch; and
a second resistor, coupled between the control terminal of the second switch and the second node.

5. The ESD protection circuit of claim 1, wherein the protection circuit comprises:
a third clamping circuit, coupled between the first power node and a third power node; and
a third diode element, coupled between the second power node and a fourth power node.

6. The ESD protection circuit of claim 5, wherein the third clamping circuit comprises:
a third switch, comprising a first terminal, a second terminal, and a control terminal, wherein the first terminal of the third switch is coupled with the first power node through a first node, the second terminal of the third switch is coupled with the third power node through a third node; and
a third sensing circuit, coupled between the first node and the third node, and configured to control the third switch according to a first node voltage of the first node and a third node voltage of the third node.

7. The ESD protection circuit of claim 6, wherein the third sensing circuit comprises:
a third capacitor, coupled between the first node and the control terminal of the third switch; and
a third resistor, coupled between the control terminal of the third switch and the third node.

8. The ESD protection circuit of claim 5, wherein the first diode element comprises:
a first transistor, comprising a first terminal, a second terminal, and a control terminal, wherein the first terminal of the first transistor is coupled with the first node, and the second terminal of the first transistor is coupled with the input node; and
a fourth resistor, coupled between the control terminal of the first transistor and the input node;
wherein the second diode element comprises:
a second transistor, comprising a first terminal, a second terminal, and a control terminal, wherein the first terminal of the second transistor is coupled with the input node, and the second terminal of the second transistor is coupled with the second power node; and
a fifth resistor, coupled between the control terminal of the second transistor and the second power node;
wherein the third diode element comprises:
a third transistor, comprising a first terminal, a second terminal, and a control terminal, wherein the first terminal of the third transistor is coupled with the fourth power node, and the second terminal of the third transistor is coupled with the second power node; and
a sixth resistor, coupled between the control terminal of the third transistor and the second power node.

9. The ESD protection circuit of claim 1, wherein the protection circuit comprises:
a third clamping circuit, coupled between the first power node and a third power node; and
a third diode element, coupled between the second power node and the third power node.

10. The ESD protection circuit of claim 9, wherein the third clamping circuit comprises:
a third switch, comprising a first terminal, a second terminal, and a control terminal, wherein the first terminal of the third switch is coupled with the first power node through the first node, and the second terminal of the third switch is coupled with the third power node through the third node; and
a third sensing circuit, coupled between the first node and the third node, and configured to control the third switch according to a first node voltage of the first node and a third node voltage of the third node.

11. The ESD protection circuit of claim 10, wherein the third sensing circuit comprises:
a third capacitor, coupled between the first node and the control terminal of the third switch; and
a third resistor, coupled between the control terminal of the third switch and the third node.

12. The ESD protection circuit of claim 9, wherein the protection circuit further comprises:
a fourth clamping circuit, coupled between the first power node and a fourth power node; and
a fourth diode element, coupled between the second power node and the fourth power node,
wherein a voltage supplied by the third power node is different from a voltage supplied by the fourth power node.

13. A display panel with protection against ESD, comprising:
an active area, comprising a plurality of pixels;
a gate driver, configured to drive the plurality of pixels; and
a plurality of ESD protection circuits, disposed in the active area or a peripheral area surrounding the active area, and configured to provide a plurality of control signals to the gate driver;
wherein each of the plurality of ESD protection circuits comprises:
a first diode element, coupled between a first power node and an input node, wherein the input node is configured to receive one of the plurality of control signals;
a second diode element, coupled between a second power node and the input node;
a first clamping circuit, coupled between the first power node and the second power node;
a second clamping circuit, coupled between the second power node and the input node; and
a protection circuit, coupled between the first power node and the second power node, and configured to transmit a current corresponding to an ESD event to a grounded capacitor.

14. The display panel of claim 13, wherein in a situation that the plurality of ESD protection circuits are disposed in the active area, the plurality of ESD protection circuits surround a part of pixels of the plurality of pixels.

15. The display panel of claim 13, wherein the first clamping circuit comprises:
a first switch, comprising a first terminal, a second terminal, and a control terminal, wherein the first terminal of the first switch is coupled with the first power node through a first node, and the second terminal of the first switch is coupled with the second power node through the second node; and
a first sensing circuit, coupled between the first node and the second node, and configured to control the first switch according to a first node voltage of the first node and a second node voltage of the second node;
wherein the second clamping circuit comprises:
a second switch, comprising a first terminal, a second terminal, and a control terminal, wherein the first terminal of the second switch is coupled with the input node, the second terminal of the second switch is coupled with the second power node through the second node; and
a second clamping circuit, coupled between the input node and the second node, and configured to control the second switch according to an input node voltage of the input node and the second node voltage.

16. The display panel of claim 13, wherein the protection circuit comprises:
a third clamping circuit, coupled between the first power node and a third power node; and
a third diode element, coupled between the second power node and a fourth power node.

17. The display panel of claim 13, wherein the protection circuit comprises:
a third clamping circuit, coupled between the first power node and a third power node; and
a third diode element, coupled between the second power node and the third power node.

18. An ESD protection structure, comprising:
a first electrode;
a second electrode, wherein the first electrode and the second electrode are disposed as extending along with a first direction;
a third electrode, disposed as extending along with a second direction, wherein the first direction is substantially perpendicular to the second direction;
a first transistor structure, wherein a drain of the first transistor structure is coupled with the first electrode, and a gate and a source of the first transistor structure is coupled with the third electrode;
a second transistor structure, wherein a drain of the second transistor structure is coupled with the third electrode, and a gate and a source of the second transistor structure is coupled with the second electrode;
a first clamping structure, coupled with the first electrode and the second electrode;
a second clamping structure, coupled with the second electrode and the third electrode; and
a protection structure, coupled with the first electrode and the second electrode,
wherein the first transistor structure, the second transistor structure, the first clamping structure, the second clamping structure, and the protection structure are disposed between the first electrode and the second electrode.

19. The ESD protection structure of claim 18, wherein the first clamping structure comprises:
a third transistor structure;
a first capacitor structure, comprising a first geometric structure and a first extension portion, wherein the first geometric structure is disposed between the third transistor structure and the first electrode, a button plate of the first geometric structure is coupled with a gate of the third transistor structure, the first extension portion is coupled with a top plate of the first geometric structure and a drain of the third transistor structure, and the first extension portion is disposed as extending from the top plate of the first geometric structure to the second electrode; and
a first resistor structure, coupled with the gate of the third transistor structure, a source of the third transistor structure, and the second electrode, comprising a plurality of first main portions and a plurality of first connection portions, wherein the plurality of first main portions are disposed as extending along with the second direction, the plurality of first connection portions are disposed as extending along with the first direction, and each of the plurality of first connection portions is coupled between two adjacent first main portions of the plurality of first main portions;
wherein the second clamping structure comprises:
a fourth transistor structure;
a second capacitor structure, comprising a second geometric structure and a second extension portion, wherein the second geometric structure is disposed between the second transistor structure and the first electrode, a button plate of the second geometric structure is coupled with a gate of the fourth transistor structure, the second extension portion is coupled with a top plate of the second geometric structure and a drain of the fourth transistor structure, and the second extension portion is disposed as extending from the top plate of the second geometric structure to the second electrode; and
a second resistor structure, coupled with the gate of the fourth transistor structure, a source of the fourth transistor structure, and the second electrode, comprising a plurality of second main portions and a plurality of second connection portions, wherein the plurality of second main portions are disposed as extending along with the second direction, the plurality of second connection portions are disposed as extending along with the first direction, and each of the plurality of second connection portions is coupled between two adjacent second main portions of the plurality of second main portions.

20. The ESD protection structure of claim 18, wherein the protection structure comprises:
a fourth electrode;
a fifth electrode, wherein the fourth electrode and the fifth electrode are disposed as extending along with the second direction;
a fifth transistor structure, wherein a drain of the fifth transistor structure is coupled with the fifth electrode, a gate and a source of the fifth transistor structure are coupled with the second electrode, and the fifth electrode is disposed between the fourth electrode and the fifth transistor structure; and
a third clamping structure, comprising:
a sixth transistor structure;
a third capacitor structure, comprising a third geometric structure and a third extension portion, wherein the third geometric structure is disposed between the sixth transistor structure and the first electrode, a button plate of the third geometric structure is coupled with a gate of the sixth transistor structure, the third extension portion is coupled with a top plate of the third geometric structure and a drain of the sixth transistor structure, and the third extension portion is disposed as extending from the top plate of the third geometric structure to the second electrode; and
a third resistor structure, coupled with the gate of the sixth transistor structure, a source of the sixth transistor structure, and the fourth electrode, comprising a plurality of third main portions and a plurality of third connection portions, wherein the plurality of third main portions are disposed as extending along with the second direction, the plurality of third connection portions are disposed as extending along with the first direction, and each of the plurality of third connection portions is coupled between two adjacent third main portions of the plurality of third main portions.
